(19) United States
(12) Patent Application Publication
(10) Pub. No.: US 2021/0334820 A1
(43) Pub. Date: Oct. 28, 2021

(54) APPLICATION FOR RULE VIOLATION NOTIFICATION

(71) Applicant: Alphan ÇELIKEL, Çigli, Izmir (TR)

(72) Inventor: Alphan ÇELIKEL, Çigli, Izmir (TR)

(21) Appl. No.: 17/270,607

(22) PCT Filed: May 23, 2019
(86) PCT No.: PCT/TR2019/050370

§ 371 Date: Feb. 23, 2021

(51) Int. Cl. G06Q 30/00; G08G 1/01; G08G 1/017; G06Q 50/26

(52) U.S. Cl. CPC G06Q 30/018; G08G 1/012; G06F 21/45; G08G 1/0175; G06Q 50/26; G08G 1/0133

(57) ABSTRACT

Disclosed is an application for rule violation notification which enables notification of the relevant violation to the authorized institutions when a rule violation is committed in traffic, wherein the application can be downloaded to smart devices.

### TECHNICAL FIELD

The invention relates to an application for rule violation notification which is used for notifying the persons who violate a rule.

The invention particularly relates to an application for rule violation notification which provides notification of the relevant violation to the authorized institutions and can be downloaded to the smart devices.

The invention also relates to an application for rule violation notification which is suitable for use in a manner such that provides notification of the other violations which is subject to penal sanction to the authorized institutions, except traffic infringement.

### PRESENT STATE OF THE ART

Today, together with the developments in technology, in order to notify the rule violations in traffic, the violations can be notified to the authorized institutions via smart devices by the users easily without the need for directly visiting the police stations. The notification of the violation can be made by means of sending short text message that includes the image of the violation to the telephone numbers that are determined by the authorized units.

In the present art, there is a mobile application for notifying the parking violations which is committed in the traffic. With this application, only parking violations can be notified. The person who reports the violation can send the image of the vehicle which belongs to the person that commits violation of parking by means of the mobile application that is downloaded to the smart device. However, when a violation is committed during traffic, there is no mobile application which enables to send the images of the violation to the authorized institution that takes criminal action against these.

In the another present art, a mobile application named as EGM Mobile which belongs to general directorate of security affairs and enables notification for traffic rule violation over Internet, is used. When the users encounter any traffic violation, they can be able to report the violation to the security units by means of creating a penal sanction record over the application by downloading EGM Mobile application to their smart phones.

When the users create a penal sanction record, they enter identity information and the location information in respect to the violation for each notification in a manual manner. Said mobile application does not comprise a system wherein the user profile in which the identity information is saved, is created and the locations are automatically received from the GPS application. When a penal sanction record is created by means of this mobile application, a proof which includes the images of the violation is not submitted. In addition to the notification system of the application, because of that said application also comprises query for parking area and the nearest police center, application for human rights violation, query for exam results of general directorate of security affairs, using this application is difficult, and comprising of many features cannot be able to provide a simple and easy usage for the users.

As a result of a research made in terms of the subject matter, a patent application is encountered with numbered TR2014/10222 titled as “A NOTIFICATION METHOD”. The application is related to a notification/complaint method which is realized by means of a mobile application which can be downloaded to the smart phone. Said application saves the images of the violation after the users press the save button when they open the mobile application and notify these to the authorized institutions. However, in said application, the location information cannot be received in an automatic manner by means of operating integrally with the GPS application of the mobile phone and the previously saved images in the gallery of the smart phone cannot be used.

As a result, due to the above-mentioned disadvantages and the insufficiency of current solutions, a development in the technical field is required to be made.

### AIM OF THE INVENTION

The invention aims to solve the above-mentioned disadvantages by being inspired from the current conditions.

The main aim of the invention is to notify the rule violations made by the drivers within the traffic without the need for directly visiting the authorized institutions.

Another aim of the invention is to notify the violation to the authorized institution with a visual proof when a rule violation is committed in traffic, by means of receiving the image of the violation via the camera of the smart device.

Another aim of the invention is to provide reduction in pecuniary and non-pecuniary damages due to the rule violation in the traffic.

Another aim of the invention is to encourage the users to obey the traffic signs and rules.

Another aim of the invention is to provide the application of the relevant penal sanctions in terms of the violations in the traffic in a more effective manner.

In order to fulfill the above-mentioned aims, the invention is a mobile application which provides users to notify the rule violations in the traffic without the need for visiting to the authorized institutions, the invention comprises at least one interface that includes at least one entrance tab wherein the users create membership by means of registering their names, surnames, identity numbers, mobile phone numbers and from which the user logins via the user name and the password created as a result of the membership and; at least one notification tab which comprises a visual proof section wherein the photograph or the video of the violation obtained from the camera of the smart device previously or instantly is saved and the location section wherein the location information of the place of violation, which saves the violation notification and the invention comprises at least one processor which enables access to the gallery of the smart device and enables uploading the photograph or video taken previously to the visual proof section, transmits the information saved in the notification tab to the authorized institutions.

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

FIG. 1 is a representative view of the inventive application for rule violation notification.

FIG. 2 is a representative view of the notification tab of the interface of the inventive application for rule violation notification.

### DESCRIPTION OF PART REFERENCES

A. Mobile application
   1. Interface
      1.1. Entrance tab
      1.2. Profile tab
      1.3. Notification tab
         1.3.1. Visual proof section
         1.3.3. Location section
      1.4. History tab
   2. Processor
      2.1. Notification code

### DETAILED DESCRIPTION OF THE INVENTION

In this detailed description, the preferred embodiments of the inventive application for rule violation notification are described only for clarifying the subject matter.

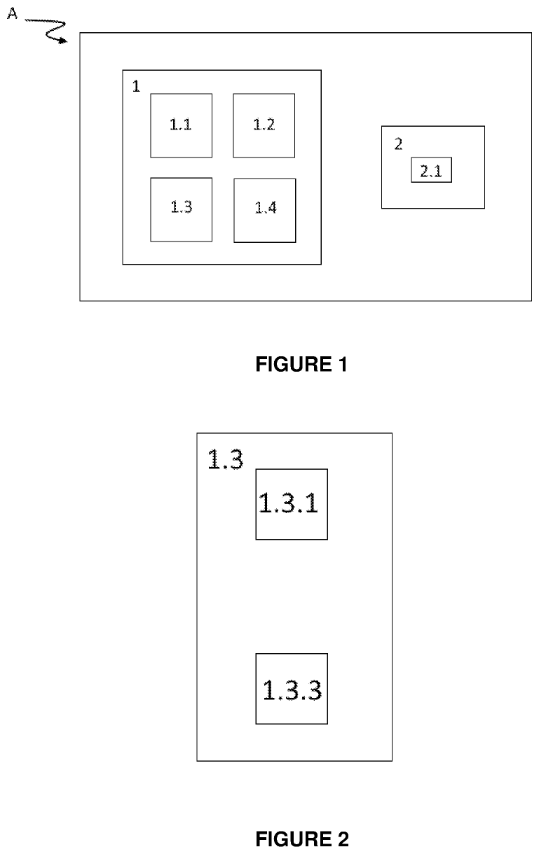

The invention which is shown in FIG. 1 in an illustrative manner comprises a mobile application (A) which comprises at least one interface (1) and at least one processor (2).

The users can be able to notify the rule violations committed by the drivers in the traffic to the authorized institutions without the need for directly visiting by means of the mobile application (A). In order to fulfill this aim, the mobile application (A) comprises;
At least one interface (1) which comprises;
   at least one entrance tab (1.1) wherein the users create membership by means of registering their names, surnames, identity numbers, mobile phone numbers and login to the application for rule violation notification via the username and the password created as a result of the membership,
   at least one profile tab (1.2) wherein personal information such as the name of the user, password of the user, telephone number, address can be saved or the user can be able to update this personal information when necessary,
   at least one notification tab (1.3) which comprises a visual proof section (1.3.1) wherein the photograph of the violation or the image obtained from the camera of the smart device previously or instantly is saved and the location section (1.3.3) wherein the location information in respect to the violation is entered and which enables saving the violation by adding visual proof or location information,
   at least one history tab (1.4) by which the users can see the violation notifications that are previously report and can see whether a penal sanction is taken against these notifications or not
and
at least one processor (2) which enables access to the gallery of the smart device and enables uploading the image or video taken previously to the visual proof section (1.3.1), transmits the information saved in the notification tab (1.3) to the authorized institutions.

When the users give access permission from the settings section of the smart devices to the mobile application (A), the processor (2) can be able to access to the gallery (it is the section where visual elements such a photograph or a video is stored). Therefore, the users can use the previously taken photographs or videos within the gallery of the smart devices as a proof and can report violation. This feature is beneficial for the users in terms of not being obliged to report violation immediately at the time of violation.

In one embodiment of the invention, the processor (2) can operate in an integrated manner with the GPS application of the smart device to which the mobile application (A) is downloaded. Users can give access permission to the mobile application (A) from the settings section of the smart devices. Therefore, in cases where the users give permission, the processor (2) enables access to the GPS application of the smart device, automatically enters the location information of the place where the violation is committed to the location section (1.3.3) and eliminates the requirement of manually saving the location information during violation notification by the users.

In one embodiment of the invention, according to the information entered to the notification tab (1.3) by means of the processor (2), a random notification code (2.1) is generated for each notification and this notification code (2.1) is saved on the processor (2). The users can make search by means of entering the notification code (2.1) generated by the processor (2) to the search section included within the history section (1.4) and can follow the previously notified violations.

With the application for rule violation notification subject to the invention, in a preferred embodiment of the invention, a notification of the violation is reported by means of the following process steps:
a. entering to the mobile application (A) that downloaded to users' smart devices by means of entering via the user's name and password by creating a membership over the entrance tab (1.1) within the interface (1), then they enter to the notification tab (1.3) within the interface (1) by users,
b. uploading the photograph or video of the violation to the visual proof section (1.3.1) within the notification tab (1.3) by taking the saved photograph or video from the gallery or taking photograph or video instantly via the camera of the smart device during the violation is reported,
c. saving the notification by means of entering the location information of the place of violation manually by the user or by taking the GPS application automatically by the processor (2), to the location section (1.3.2) within the notification tab (1.3),
d. notifying the violation which is saved to the notification tab (1.3) to the authorized institution by the processor (2)

In one embodiment of the invention, after the users login the mobile application (A) over the entrance tab (1.1) with the user's name and password, they can update their personal information such as user's name, user's password, telephone number, address etc. that they saved previously by means of entering to the profile tab (1.2).

In one embodiment of the invention, the application for rule violation notification can operate in an integrated manner with the e-Devlet system of the government. In case the government accepts to operate the e-Devlet service with the application for rule violation notification in an integrated manner, the users without creating a new membership login directly with e-Devlet information and can notify violation. The notifications made by the users can be stored in the servers of the e-Devlet service. In case the government does not accept to operate the e-Devlet service with the application for rule violation notification in an integrated manner, the notified violations can only be stored in the servers belong to the application for rule violation notification and access permission to these servers is given to the institution to which the notification is made (general directorate of security affairs). Therefore, the authorized institution evaluates the notifications made and can decide whether to take criminal action against the citizen who commits violation or not.

1. A mobile application which enables notifying rule violations in traffic directly without the requirement of visiting to the authorized institutions, characterized by comprising:
at least one interface comprising:
at least one entrance tab wherein users create membership by means of registering their names, surnames, identity numbers, mobile phone numbers and login with the users' name and password created as a result of this membership; and,
at least one notification tab which comprises a visual proof section wherein the photograph or video of the violation obtained from the camera of the smart device previously or instantly is saved and a location section in which the location information is saved, wherein the violation is saved; and
at least one processor which enables access to the gallery of the smart device and enables uploading the photograph or video taken previously to the visual proof section, transmits the information saved in the notification tab to the authorized institutions.

2. A mobile application according to claim 1, comprising an interface comprises at least one profile tab wherein the users can update the information that are registered during membership.

3. A mobile application according to claim 1, comprising at least one interface that comprises at least one history tab in which the users can view their previous violation notifications and can view whether a penal sanction is taken as a result of these notifications or not.

4. A mobile application according to claim 1, wherein the processor generates and saves a random notification code for each notification according to the information entered to the notification tab.

5. A mobile application according to claim 4, comprising a history tab which enables following the violation notifications notified to the authorized institution by means of entering the notification code which is generated in the processor.

6. A mobile application according to claim 1, comprising a processor which automatically enters the location information of the violation to the location section by means of having access to the GPS application of the smart device.
